(19) United States
(12) Patent Application Publication
(10) Pub. No.: US 2024/0377201 A1
(43) Pub. Date: Nov. 14, 2024

(54) VISUALIZATION AND TRACKING SYSTEM

(71) Applicant: Michael Cohen, Gush Ezyon (IL)

(72) Inventor: Michael Cohen, Gush Ezyon (IL)

(21) Appl. No.: 18/683,664

(22) PCT Filed: Jul. 17, 2022
(86) PCT No.: PCT/IL2022/050767

§ 371 Date: Feb. 14, 2024

(30) Foreign Application Priority Data
Jul. 15, 2021 (IL) 284897

(51) Int. Cl. G01C 21/16; H04W 12/06

(52) U.S. Cl. CPC G01C 21/1656; H04W 12/06

(57) ABSTRACT

This invention provides systems and methods for determining and capturing desired perspective views of objects of interest (OOIs) including locating each OOI and determining an orientation of each OOI, or simultaneously detecting and tracking multiple objects of interest while assigning a position in space for each OOI and further securely transmitting the captured information to a remote location.

### BACKGROUND OF THE INVENTION

Various systems have been developed for determining and capturing desired perspective views of objects of interest (OOIs), including locating each OOI and determining an orientation of each OOI, or simultaneously detecting and tracking multiple objects of interest while assigning a position in space for each OOI.

Being able to efficiently track an OOI spatially and remotely obtain such tracking data has clear defense and security implications, and the currently available systems suffer many limitations, including, inter alia, the ability to locate and determine a location/orientation of an OOI and transmit information regarding same via secure means to a remote location.

### SUMMARY OF THE INVENTION

It is an object of this invention to provide a system for determining and capturing desired perspective views of objects of interest (OOIs) including locating each OOI and determining an orientation of each OOI, or simultaneously detecting and tracking multiple objects of interest while assigning a position in space for each OOI and further securely transmitting the captured information to a remote location.

It is an object of this invention to provide a system that can identify obscured or otherwise hidden or secreted passageways and strategic objects, locations, or object placement at particular locations, which system can further collect and transmit the collected information securely to a remote location.

In some embodiments, the visualization and tracking systems of this invention comprise a local data collection unit comprising a microprocessor, sensor activated cameras, a gyroscope, a power supply/batteries, communication transmission elements and optionally a pedometer and further optionally a digital compass and a remote data receiver unit comprising secure communication receiver elements.

In some embodiments, the communication between the local data collection unit and the local data collection unit is with the aid of a subscriber identification module (SIM), securely storing a key for identification and unique authentication for access by the remote data receiver unit.

In some embodiments the data collected and stored on the microprocessor for transmission is encrypted in addition to being compacted for rapid secure transmission.

In some aspects, the data collection is pre-programmed to occur based on a desired time schedule or in some embodiments, based on a defined motion activation, or in some embodiments, based on a defined depth location of the transmission unit, or in some embodiments, based on other pre-defined parameters.

In some aspects, the data collection program may be modified in real time, and according to this embodiment, the local data collection unit executable programs can be updated on the microprocessor.

In some embodiments, the system comprises a microprocessor and controller equipped for remote activation of the data collection unit, such that a signal is delivered to same via receiver in the data collection unit, whereby activation of the system then commences following receiving of such signal.

In some aspects, the microprocessor is operationally connected to a SIM card, whereby encrypted data may then be transmitted to a secure server, via secure protocol, for example, when the data collection unit is in physical proximity to a secure location containing a data receiver unit of this invention, subject to the availability of appropriate reception and secure identification.

According to this aspect, and in some embodiments, when the data collection unit is in physical proximity to a secure location containing a data receiver unit of this invention, an electronic signal is transmitted to the microprocessor, which upon receiving same, initiates transmission of encrypted compacted data to the data receiver unit, where the data is then processed and analyzed.

In some embodiments, data transmission may be over a course of time, including, in some aspects, in multiple transmissions, and in some embodiments, each transmission event deletes the stored data already transmitted so that minimal stored data is located in the data collection unit whenever possible, as a security precaution.

According to this aspect and in some embodiments, the visualization and tracking systems of this invention provide for collection of directional/movement data at a desired location of placement of the system. According to this aspect and in some embodiments, the transmission of information collected at the local data collection unit is aided by the incorporation of a SIM in said data collection unit, which facilitates use of a cellular network, when the local data collection unit is in proximity with same and the encrypted, compacted data collected from the cameras, pedometer and gyroscope stored on the microprocessor is sent when appropriate.

In some embodiments, the visualization and tracking systems of this invention comprises a microprocessor and user interface, for example, a linux-based system, which in turn transmits a signal to the processor to execute a series of commands.

According to certain aspects of the invention, the microprocessor is operationally connected to a number of components of the system, such as different sensors, and the microprocessor is also operationally connected to a cellular network, by means of the SIM contained therein, which promotes the transmission of the collected, compacted, encrypted data to the data receiver unit when the data collection unit is in proximity with such cellular network and optionally, when a secure command is received by the data collection unity serving as authentication/part of a security protocol for transmission.

In some embodiments, the microprocessor can be any appropriate microprocessor, for example, such as the Raspberry Pi4, or other suitable microprocessors, as will be known to the skilled artisan. In some embodiments, the microprocessor will be small and efficient in terms of its power usage.

In some aspects, the microprocessor is operationally connected to other components of the systems/devices of this invention, for example, via the aid of a miltiplexer/USB. In some aspects, the components are provided in direct contact with the microprocessor, and in some aspects, the connection may comprise a combination of the two.

In some aspects an array of miniaturized HD wireless cameras are operationally connected to the microprocessor. According to this aspect and in some embodiments, the cameras capture video and still images. In some embodiments, recording of information by the camera is on the basis of a motion detector, which activates capturing images/video.

In some embodiments, the devices/systems of this invention include memory storage means, in operational connection with the miniaturized cameras, such that the information can be stored externally to the cameras.

In some embodiments, the memory storage means includes a non-transitory memory that stores data for providing the functionality described herein. The memory may be a dynamic random access memory (DRAM) device, a static random access memory (SRAM) device, flash memory or some other memory devices. In some embodiments, the memory may include one or more camera memory cards for storing raw video data (e.g., image frames) captured by the camera module. Example memory cards include, but are not limited to, a secure digital (SD) memory card, a secure digital high capacity (SDHC) memory card, a secure digital extra capacity (SDXC) memory card, and a compact flash (CF) memory card, etc.

In some embodiments, the miniaturized HD wireless cameras have highly sensitive motion sensors which activate recording automatically and essentially immediately, so that image and video capture is readily accomplished once a part of the device is for example, subject to motion/movement or movement is detected near to the location of the device/systems of this invention.

In some embodiments, the miniaturized HD wireless cameras are very small, easily obscured, equipped to record images using infrared technology under dark conditions and possess minimal power requirements to record same.

The microprocessors of the devices/systems of this invention are also operationally connected to other components of the systems/devices of this invention, such as, for example, a pedometer or a digital gyroscope/accelerometer or a combination thereof. According to this aspect, and in some embodiments, these components are provided in direct contact with the microprocessor, and in some embodiments, these components are provided contact indirectly, for example, via the aid of a multiplexer/USB and in some aspects, the connection may comprise a combination of the two.

According to this aspect and in some embodiments, the gyroscope/accelerometers for use in the devices/systems of this invention may be any appropriate model that can be discreetly incorporated within the local data collection units of this invention, as will be appreciated by the skilled artisan.

In some embodiments, the local data collection units of this invention may further comprise a pedometer, which in turn may be in coordinated use with the gyroscope/accelerometer, such that an overlay of the distance the unit traverses can be provided to provide meaningful location information so that, for example, images/video captured can be correlated and plotted on a map to indicate collection as a consequence of spatial orientation.

It will be appreciated that the input data from the cameras and that from the pedometer/digital gyroscope are in some aspects, simultaneously acquired or nearly simultaneously acquired, such that image/video captured data can be correlated with location information similarly collected through any number of means, as will be known to the skilled artisan.

In some embodiments, the local data collection unit will comprise audio capture elements such as a miniaturized microphone. In some embodiments, the local data collection unit may comprise a microphone array for capturing sound from multiple directions. According to this aspect, and in some embodiments, the data collection unit may further comprise sensors for voice or other sound activated operation of the audio capture element. According to this aspect and in some embodiments, the audio capture may be independent of the video capture. In some embodiments, the audio capture may be independent of the input data acquired by the pedometer/digital gyroscope.

In some embodiments, input data from the microphone/audio capture and that from the cameras and/or that from the pedometer/digital gyroscope are in some aspects, simultaneously acquired or nearly simultaneously acquired, such that captured audio data can be correlated with image/video captured data and/or can be correlated with location information similarly collected to correlate image and audio data as a function of location and time.

In some embodiments, the local data collection unit is discreet and the components of same are similarly discreet such that same can be located in any convenient casing, such as, for example, casings of materials for other purposes. According to this aspect and in some embodiments, such local data collection unit may effectively be hidden within a container such as a container used in construction, or article of furniture, or any convenient infrastructure object.

In some embodiments, the local data collection unit is discreet and the components of same are similarly discreet such that same can be located in an electronics device, such as a tablet or appliance or other article in daily use, whereby power usage of the local data collection unit located therein is obscured.

In some embodiments the local data collection unit further comprises a self-contained battery unit, whereby the batteries are long life batteries, capable of providing sufficient power for the unit for a prolonged period of time.

The local data collection units of this invention will be further equipped with a communication unit. According to this aspect, and in some embodiments, the communication unit will comprise a SIM, which in turn provides for wireless reception, which is coupled to a discreet antenna, for ease of data transfer as herein described.

The visualization and tracking systems of this invention further comprise a data receiver unit, which in turn comprises a communication unit, as well, for sending and receiving information from the local data collection unit of the system, including, in some embodiments, a SIM and appropriate antenna.

According to this aspect, and in some embodiments, the data receiver unit may provide a test signal or encoded instructions, which facilitate data transfer from the local data collection unit to the data receiver unit. In some embodiments, the data transfer is encrypted and provided with multiple security protocols to ensure that data transfer from the local data collection unit is provided exclusively to an authorized data receiver unit, and data cannot be transferred to an unauthorized receiver unit.

The data receiver unit will in turn further comprise a processor and server, whereby transferred data can be stored and processed.

The data receiver unit server may comprise the processor and further comprise a memory, and network communication capabilities. In some embodiments, the server receives encrypted, compressed video data, which data is then de-encrypted and decompressed and processed, for example, to generate 3D video data or matched video and locational data as described herein, and stores the 3D video data, or other processed data in a storage associated with the server. In some embodiments, the server includes a data aggregation system for receiving raw image/video data and aggregating the raw image/video data to create 3D image/video data.

In some aspects, the data receiver unit will be further connected to a network, which may be a conventional type, wired or wireless, and may have numerous different configurations including a star configuration, token ring configuration or other configurations. Furthermore, the network may include a local area network (LAN), a wide area network (WAN) (e.g., the Internet), or other interconnected data paths across which multiple devices may communicate. In some embodiments, the network may be a peer-to-peer network. The network may also be coupled to or include portions of a telecommunications network for sending data in a variety of different communication protocols. In some embodiments, the network may include Bluetooth communication networks or a cellular communications network for sending and receiving data including via short messaging service (SMS), multimedia messaging service (MMS), hypertext transfer protocol (HTTP), direct data connection, WAP, email, etc.

In some embodiments, the system may additionally include a viewing system. The viewing system may, in some embodiments, decode and render the image/video data on a VR display.

The processor component of either the local data collection unit or the remote data receiver unit or a combination thereof, may include an arithmetic logic unit, a microprocessor, a general purpose controller or some other processor array to perform computations and, in regard to the remote data receiver unit, provide electronic display signals to a display device. The processor may be coupled to a bus for communication with other components. The processor may process data signals and may include various computing architectures including a complex instruction set computer (CISC) architecture, a reduced instruction set computer (RISC) architecture, or an architecture implementing a combination of instruction sets.

Various processors, operating systems, sensors, displays and physical configurations of the components of the local data collection unit or the remote data receiver unit or a combination thereof are envisioned.

In some embodiments, the local data collection unit, remote data receiver unit or a combination thereof will comprise a memory, which may include, inter alia, non-transitory memory that stores data for providing the functionality described herein, including a dynamic random access memory (DRAM) device, a static random access memory (SRAM) device, flash memory or some other memory devices.

This invention further provides a method for visualization and tracking of a target, the method comprising providing a local data collection unit to or at a target whose visualization and tracking is desired, where the local data collection unit comprises a microprocessor, sensor activated cameras, a gyroscope, a power supply/batteries, communication transmission elements and optionally a pedometer and further optionally a digital compass, and promoting secure communication between the local data collection unit and a remote data receiver unit comprising secure communication receiver elements, whereby data collected and stored on the local data collection unit is securely transmitted to the remote data receiver unit for processing to serve as a means of visualizing and tracking the target.

In some embodiments, the methods of this invention provide for automated detection and tracking of multiple targets.

In some embodiments, an apparatus and program product also perform the functions of the method, which is to be considered as part of this invention.

### BRIEF DESCRIPTION OF THE DRAWINGS

Various embodiments of the devices, systems and methods of this invention are described herein with reference to the figures wherein:

FIG. 1 depicts an embodied non-limiting example of elements of a visualization and tracking system of this invention.

FIG. 2 depicts a flow diagram of an embodied non-limiting example of operation of an embodied visualization and tracking system of this invention.

FIG. 3 depicts an elements of an embodied non-limiting example of the organization of certain components of a visualization and tracking system as herein described.

FIG. 4A-4I depicts an embodied non-limiting example of the operation of an embodied visualization and tracking system of this invention.

FIG. 5 depicts a plot of spatial data obtained when deploying a visualization and tracking system as herein described in a subterranean setting.

FIG. 6 plots the spatial data as described in FIG. 5 over a satellite map at a defined geographic locale.

FIGS. 7A-7E depicts an embodied non-limiting example of operation of an embodied visualization and tracking system of this invention.

FIG. 8 depicts an embodied non-limiting example of data collection via the visualization and tracking system of this invention.

FIGS. 9A-9B depict an example of a captured image and correlated geographical/spatial location of the image location.

FIG. 10 depicts a further embodied non-limiting example of elements of a visualization and tracking system of this invention.

### DETAILED DESCRIPTION OF THE INVENTION

While systems for determining and capturing desired perspective views of objects of interest (OOIs) including locating each OOI and determining an orientation of each OOI, or simultaneously detecting and tracking multiple objects of interest while assigning a position in space for each OOI have been developed in a very limited fashion, systems and methods that and further securely transmit the captured information to a remote location are either unknown or unreliable.

In some aspects, the systems and methods of this invention seek to identify obscured or otherwise hidden or secreted passageways and strategic locations in addition to other sensitive information such as, sensitive targets. Uniquely, the systems and methods of this invention can transmit the collected information securely to a remote location.

In some embodiments, the visualization and tracking systems of this invention comprise a local data collection unit, comprising:
a microprocessor;
one or more sensor activated cameras;
a gyroscope and accelerometer assembly and optionally a pedometer;
communication transmission elements; and
a power source.

In some embodiments, the local data collection unit is means to discretely and imperceptibly provide for collection of visual and optionally auditory data, and provide storage for same within a minimal framework, while simultaneously recording geographic/location information as to hallmarks in terms of latitude and longitude, correlating with the visual/audio data being collected. According to this aspect, and in some embodiments, such data collection can then proceed with minimal detection of same.

According to this aspect and in some embodiments, data collection in the local data collection unit can be accomplished via minimal power requirements so that when the local data collection unit is located at a sensitive region, such data can be collected and stored and later transmitted via highly secure means to a remote location.

According to this aspect and in some embodiments, the data collection is via means of one or more sensor activated cameras, for example, cameras that are motion-detection activated to record images/video when movement is detected near a sensor operationally connected to the camera.

In some embodiments, the array of cameras are so positioned as to have a first camera module possess at least one overlapping field of view with a second camera module. In some embodiments, the camera modules are synchronized through a daisy chain to capture corresponding images/video data in different directions simultaneously; wherein the camera modules pass control and status messages to one another via the daisy chain.

According to another aspect, the local data collection unit receives image/video data comprising image frames from the camera modules; and the remote data receiver unit can thereafter following transfer of the compressed encrypted data, stitch together the image frames based on the video data; generating three-dimensional video; and optionally further synchronize audio data; generating a stream of the three-dimensional video and the audio data, enabling detailed display of panoramic image and audio information.

The camera array may include multiple camera modules comprising a processor, a memory, a sensor, a lens and combinations thereof. The camera modules in the camera array may be coupled in a daisy chain for passing control and status messages to one another via the daisy chain and synchronizing timing of image frames captured by different camera modules.

The camera modules in the camera array may be configured in different geometries. For example, the camera array includes multiple camera modules arranged in a line, a cylinder, a sphere, or another geometry. Each camera module may be configured to point to a different direction so that the camera array may capture an object or a scene from multiple directions at the same time.

The camera system described herein may include two types of communication mechanisms, including a first communication mechanism for data communication between the different camera modules (e.g., a bus for communication between the different camera modules) and a second communication mechanism for centrally controlling the operation of the camera modules (e.g., a control bus for controlling operations of the camera modules).

In some embodiments, the local data collection unit may comprise a plurality of cameras that are in standby mode, and activated at desired times to collect desired data.

In some aspects, the data collection is pre-programmed to occur based on a desired time schedule or in some embodiments, based on a defined motion activation, or in some embodiments, based on a defined depth location of the transmission unit, or in some embodiments, based on other pre-defined parameters.

In some aspects, the data collection program may be modified in real time, and according to this embodiment, the local data collection unit executable programs can be updated on the microprocessor.

It will be appreciated that any number of microprocessors and miniaturized cameras are known and many commercially available options exist and the invention is not to be limited in any way.

In some embodiments, the Raspberry Pi4 microprocessor may be easily incorporated in the devices/systems/methods of this invention and are suitable for use in connection with same due to their low power requirements, ease in which same are attainable and in some embodiments, are so prolifically found globally that undesired detection of same would not necessarily prophesy the purpose for which the system was deployed.

In other embodiments, microprocessors of any desired type can be used, such as, for example, those manufactured by Amulet Technologies, Analog Devices, Western Design Center, STMicroelectronics, Infineon Technologies, GHI Electronics and others, as will be appreciated by the skilled artisan.

Similarly, many HD minicameras may be incorporated in the devices/systems/methods of this invention. For example, and in one embodiment, an SQ11 Camera may be used, and in some embodiments, any appropriate HD minicamera that can be discreetly incorporated in the devices/systems/methods of this invention. In some embodiments, the cameras will be motion activated, and in some embodiments, night vision cameras will be used, which in some embodiments, may be equipped with wide angle lenses, as well.

The microprocessor will be operationally connected to the one or more minicameras so that the images will be collected, compacted and stored and ultimately transmitted.

In some embodiments, the phrase “operationally connected” refers to the presence of elements such that the indicated parts are directly or indirectly connected and that the indicated parts are therefore capable of functioning properly.

“Operationally connected” refers, in some embodiments, to a configuration of elements such as the microprocessor and/or other listed device components, wherein an action or reaction of one element affects another element, but in a manner that preserves each element's functionality. Operationally connected device components refers to an arrangement wherein information/data collected from, for example, the sensors, pedometer, digital gyrosope/accelerometer, and/or cameras is transmitted to another device component, such as, the microprocessor and/or transmitted from the device via the communication transmission elements. Operationally connected device components may be in contact, for example in direct physical contact, or in other embodiments, operationally connected device components may be connected by one or more intervening components.

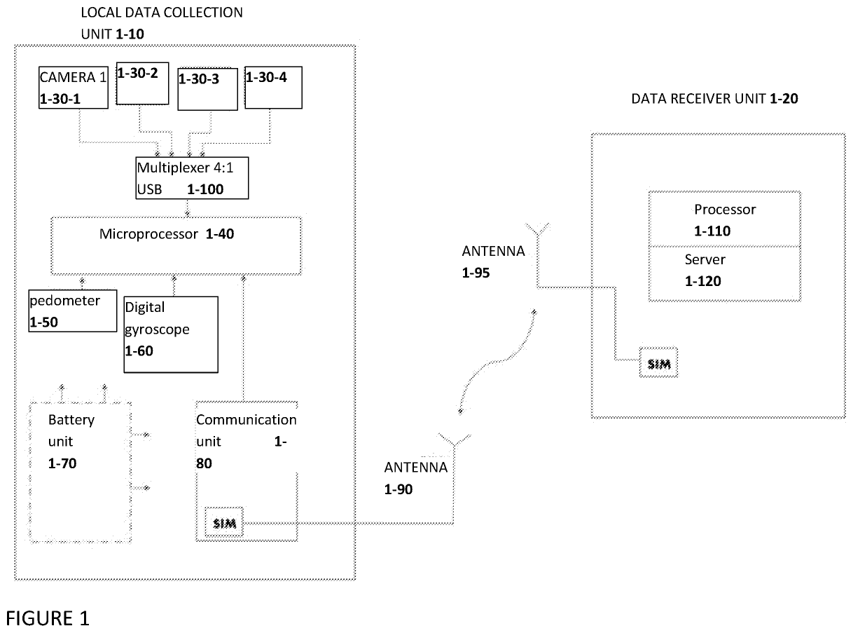

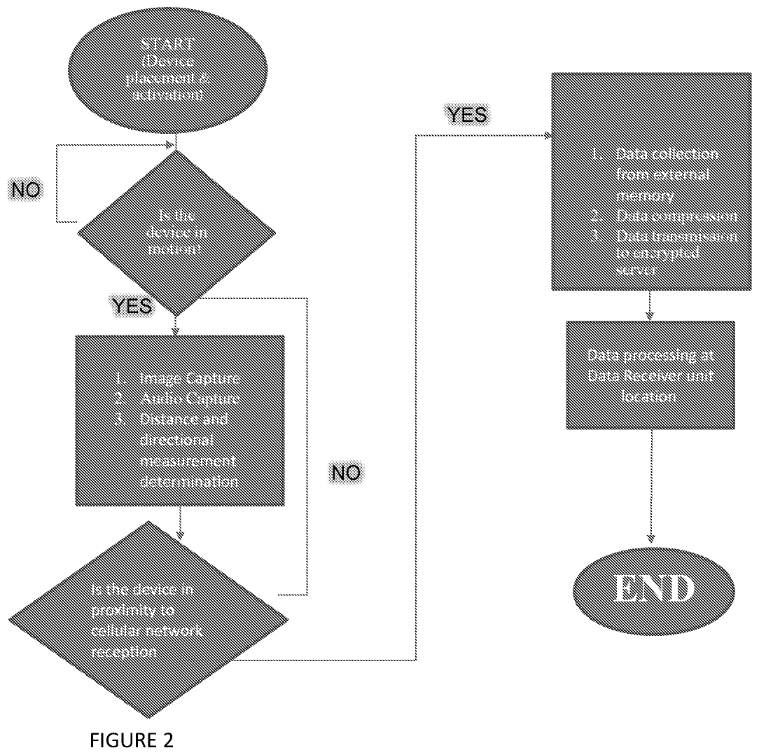

Referring to FIG. 1, an embodied local data collection unit 1-10 is shown. The microprocessor 1-40 is operationally connected to a plurality of microcameras 1-30-1—1-30-4, with the aid of a multiplexer 1-100. Sensors are provided with the minicameras to detect motion, such that, as depicted in FIG. 2, when the device is in motion, the cameras capture the video and optionally the audio feeds at the site of placement/containment of the local data collection unit.

The microprocessor is also operationally connected to a digital gyrosope/accelerometer 1-60 and pedometer 1-50, which in turn facilitates correlating the captured images/video/audio with a distance/directional measurement as ascertained/determined by the gyroscope/pedometer.

The elements of the visualization and tracking devices, embodied components of which are depicted, for example in FIG. 1 and described herein, may be connected via any suitable and convenient means as is known in the art, for example, via wires or other connecting components.

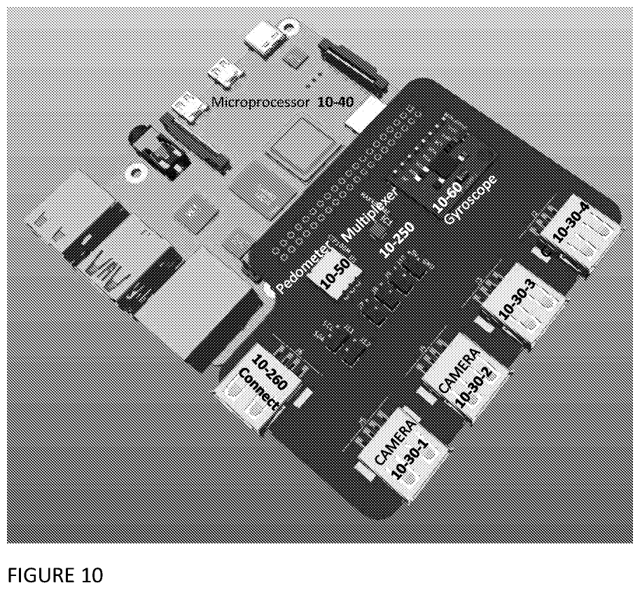

In some embodiments, some of the elements may be conveniently positioned on an appropriate card, for example as depicted in FIG. 10, where the microprocessor 10-40 is operationally connected to a plurality of microcameras 10-30-1-10-30-4, with the aid of a multiplexer 10-250. The microprocessor may also be operationally connected to a digital gyrosope/accelerometer 10-60 and pedometer 10-50. The card may be with additional connectors 10-260 to connect to the microprocessor, as will be understood by the skilled artisan.

Many commercially available digital gyroscopes are known and suitable for use in accordance with this invention. For example and in some embodiments, DFRobot's SEN0142 motion sensing tri-axis angular motion sensor (gyroscope) and a tri-axis accelerometer may be used, or any comparable gyroscope/accelerometer may be used.

Similarly, many commercially available pedometers are envisioned for use, such as, for example the DSPX01 3D pedometer equipped with a 3 axes acceleration sensor (MEMS G sensor) and a low power high performance MCU, and the like.

The local data collection unit will comprise a battery unit 1-70, to power the elements of the unit as herein described. Any appropriate battery unit/power source/supply for use is envisioned. For example, and in some embodiments the battery unit may comprise a Mobile lithium battery, which may be rechargeable.

The local data collection unit will further comprise a communication unit 1-80, which contains communication transmission elements, as described, such as a subscriber identification module (SIM), securely storing a key for identification and unique authentication for access by the remote data receiver unit. Any appropriate SIM can be used, for example, a Quectel EC25-E Mini PCIE 4G/LTE Module may be incorporated.

An appropriate antenna 1-90 will be incorporated in the local data collection unit, as well, for example, such as a LTE Main & Diversity & GNSS Triple Port Antenna or any other appropriate antenna for use.

The communication unit serves to facilitate the data transmission when the local data collection unit is in proximity to a secure, cellular network, where reception is available.

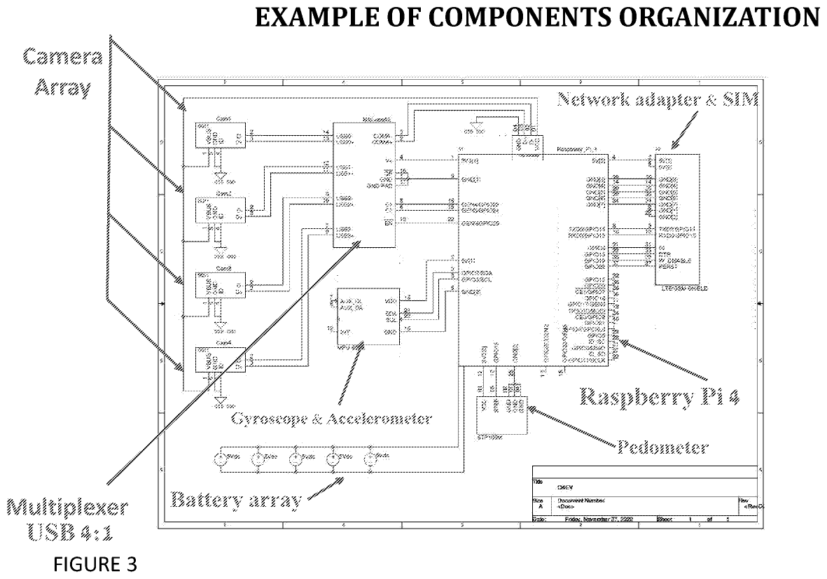

FIG. 3 provides a schematic representation of some of the components and their organization, for an embodied local data collection unit of this invention.

It is to be understood that any number of different permutations of the local data collection unit are contemplated, including fewer or additional cameras in the array, alternative microprocessors, batteries and/or additional components and the invention is not to be in any way limited to the illustrative examples provided herein as same are intended for reference purposes and are not to be construed as limiting the invention in any way.

This invention provides, in some embodiments, a method for visualization and tracking of a target, said method comprising:
providing a local data collection unit to or at a target whose visualization and tracking is desired;
wherein said local data collection unit comprises:
   a microprocessor;
   one or more sensor activated cameras;
   a gyroscope;
   a power source; and
   communication transmission elements; and optionally
   a pedometer;
providing a remote data receiver unit comprising secure communication receiver elements,
promoting secure communication between said local data collection unit and said remote data receiver unit;
whereby data collected and stored on the local data collection unit is securely transmitted to said remote data receiver unit;
   processing data received by said data receiver unit in terms of visualization and tracking of said target.

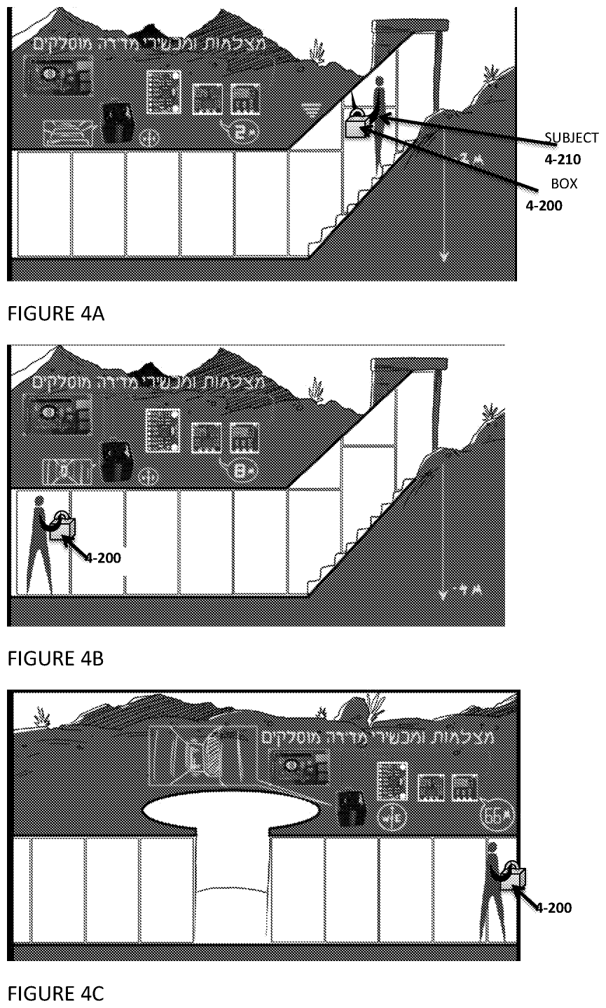

Referring now to FIGS. 4A-4I, a small discrete local data collection unit is provided so that an individual can easily carry same in any convenient means.

In some aspects, a person 4-210 may carry a small box 4-200 on his person. The box is equipped with the elements of the local data collection unit as described and as the subject enters a target area of interest, he may descend a staircase as shown in panel 4A, whereby the system cameras are activated by the sensors detection movement of the person through the target area of interest.

According to this embodiment and in some aspects, the gyroscope/accelerometer/pedometer contained in the local data collection unit facilitate recording of the subterranean depth descended and moreover generates a relative map, based on the direction of movement and collection of images from the camera as the subject 4-210 moves along the defined passageway.

As the subject advances down the passageway (see for example, panels, 4C, 4E, 4F, 4G) the motion-activated cameras record video/images and optionally audio recording is conducted as well. Furthermore the gyroscope/accelerometer/pedometer continue to be active during this time, as well so that the captured images/video/audio can be correlated with geographic coordinates and other distance identifying information.

When the discrete local data collection unit 4-200 is stationary, for example as in panel 4D, as a battery conservation mode, in the absence of detection of motion, the system powers down and collect data. Upon resumption of movement of the subject, as in Panel 4E, the system is reactivated and data collection may be resumed.

In some aspects, upon subject exit of the passageway, as depicted for example in panel 4I, the local data collection unit will be brought into proximity with a secure remote data receiver unit, and in some embodiments, a transmission signal is provided from the remote data receiver unit to the local data collection unit, which in turn activates compression, encryption and transmission of the data collected by the local data collection unit while the unit was within the passageway.

As described herein, the visualization and tracking system will further comprise a remote data receiver unit 1-20, comprising secure communication receiver elements, a processor 1-110 and a server 1-120, so that compacted encrypted data transmitted from the local data collection unit can be received, e.g. via an antenna 1-95 located on the data receiver unit, similarly operationally connected to a comparable communication unit or SIM on the data receiver unit.

Referring to FIG. 2, data collected from memory on the data collection unit is compressed and transmitted to an encrypted server located on the data receiver unit, and subsequently the data is decompressed, and processed and then subjected to analysis to yield the objects of interest (OOIs) including location and orientation of each OOI and assigning a position in space for each OOI.

In some embodiments, the communication between the local data collection unit and the remote data receiver unit is with the aid of a subscriber identification module (SIM), securely storing a key for identification and unique authentication for access by the remote data receiver unit.

In some embodiments the data collected and stored on the microprocessor for transmission is encrypted in addition to being compacted for rapid secure transmission.

Referring for example to FIGS. 4A-4I, the video/captured images depicted in each frame may also represent data collected using the devices/systems and in accordance with the methods of this invention.

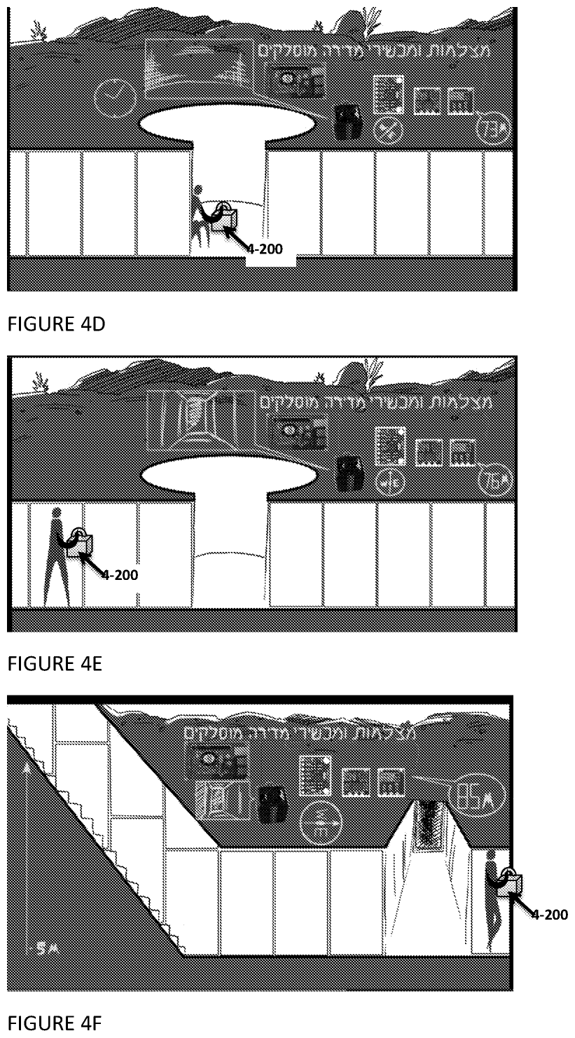

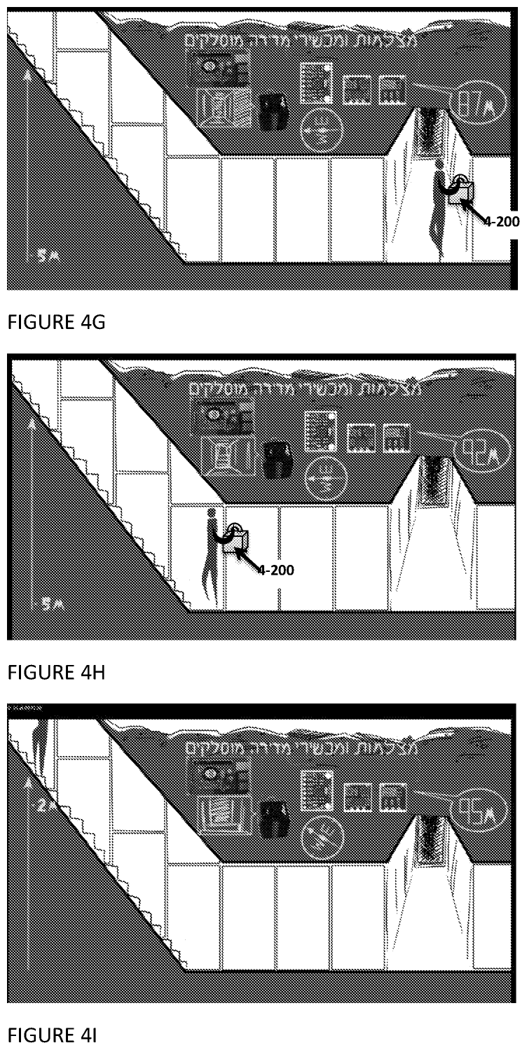

According to some aspects of this invention, in addition to the series of images provided, a map indicating the trajectory/spatial traversal undergone by the local data collection unit is generated by the remote data receiver unit, for example, as depicted in FIGS. 5 and 6, where spatial data is plotted and overlaid on a satellite map to provide an indication of the route, turns and distance traveled in the passageway.

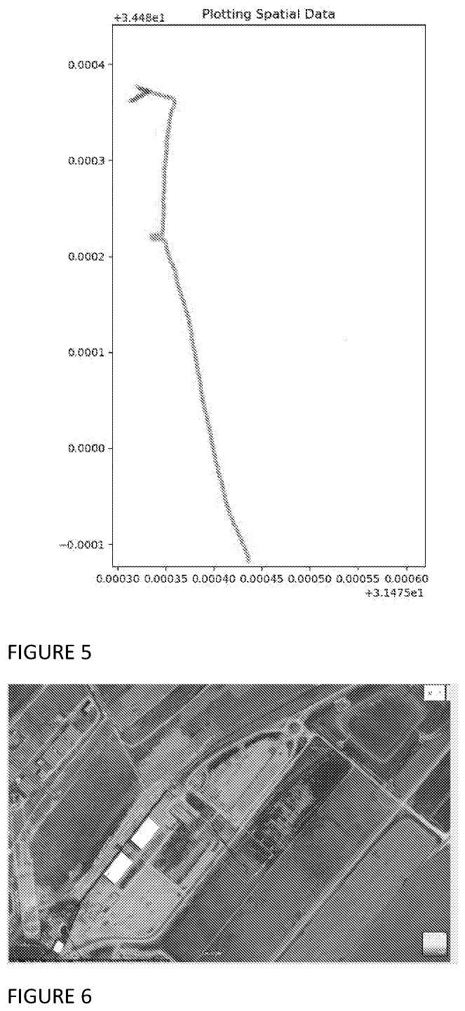

Referring to FIGS. 7A-7E, the methods of this invention provide for introducing a local data collection unit to a target, whereby data acquisition at a target location can be accomplished. For example, and in some embodiments, the local data collection unit is of discrete, portable and compact design, fitted in, for example, a worn accessory, such as in a watch, pocket book or attached case, sneaker or other worn article. In other embodiments, the local data collection unit is fitted in, for example, a container in typical use, such as for construction or irrigation or other in demand uses.

It will be appreciated that the local data collection unit being of discrete, portable and compact design can be fitted in almost any appropriate desirable object and used for the purposes as described herein and is not to be in any way limited thereby in its application.

Once the local data collection unit is introduced at or near a target site, in some embodiments, the system may be initially prompted for collection, for example, by delivery of an initiation signal from a remote data receiver unit. In some aspects, the signal delivered from the remote data receiver unit to initiate activation is secure/encrypted.

Referring to FIGS. 7A and 7B, the upon the local data collection unit being in secure communication with the remote data receiver unit, a signal is transmitted from the local data collection unit to the remote data receiver unit signifying that the system awaits a command to initiate data collection protocols. A command is then transmitted from the remote data receiver unit for same, which activates the device to collect data, in some embodiments, instantaneously, or in some embodiments, in accordance with pre-programmed criteria.

According to this aspect and in some embodiments, the local data collection unit activation may rely on receipt of an initiation signal or in some embodiments, activation may rely on motion sensing or depth sensing, or in some embodiments, local data collection unit activation may rely on pre-programmed criteria such as time, distance travelled, sensors detecting certain environmental signals, and others as will be appreciated by the skilled artisan.

Similarly, referring to FIGS. 7C and 7D, the local data collection following data collection may receive a signal or command transmitted from the remote data receiver unit to the local data collection unit to indicate that data collection should conclude and data should be compressed and transmitted when complete and/or secure transmission is feasible.

In some embodiments, the signal or command for the local data collection unit to conclude data collection may rely on signal transmission for same, or in some embodiments, may rely on pre-programmed conditions, such as, for example, power usage detection, physical conditions changing at the target site, environmental changes at the target site, pre-programmed time intervals for collection, or any pre-programmed criteria such as distance travelled, sensors detecting communication/network activity, and others as will be appreciated by the skilled artisan.

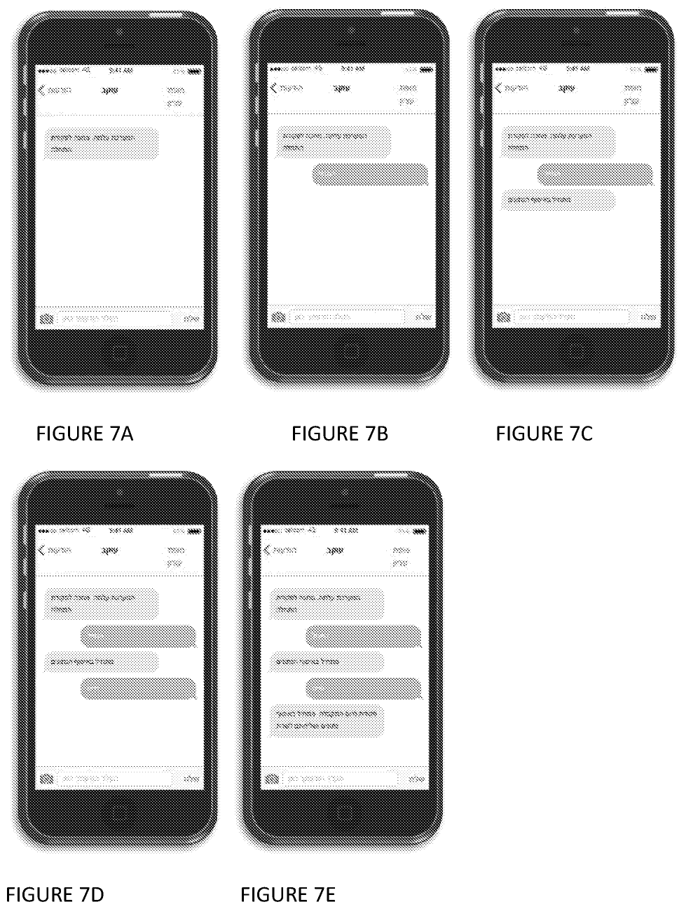

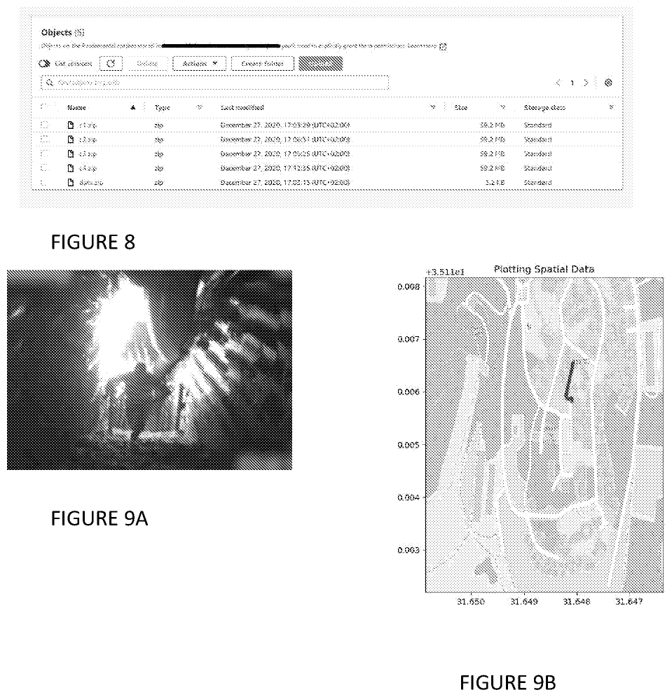

FIG. 8 provides an example of a series of compressed files, which, in some embodiments, illustrate the data files for transfer in accordance with the devices/systems/methods of this invention. Similarly, FIGS. 9A and 9B provide single images/maps of acquired data for use in accordance with the devices/systems/methods of this invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be understood by those skilled in the art that various changes in form and details may be made therein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims.

All publications, patents, and patent applications mentioned herein are hereby incorporated by reference in their entirety as if each individual publication or patent was specifically and individually indicated to be incorporated by reference. In case of a conflict between the specification and an incorporated reference, the specification shall control. Where number ranges are given in this document, endpoints are included within the range. Furthermore, it is to be understood that unless otherwise indicated or otherwise evident from the context and understanding of one of ordinary skill in the art, values that are expressed as ranges can assume any specific value or subrange within the stated ranges, optionally including or excluding either or both endpoints, in different embodiments of the invention, to the tenth of the unit of the lower limit of the range, unless the context clearly dictates otherwise. Where a percentage is recited in reference to a value that intrinsically has units that are whole numbers, any resulting fraction may be rounded to the nearest whole number.

In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g. in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format. The following examples describe certain embodiments of the invention and should not be construed as limiting the scope of what is encompassed by the invention in any way.

### EXAMPLES

### Example 1

### Deployment of an Embodied Visualization and Tracking System in a Field Setting and Secure Transmission and Remote Receipt of Spatial Data Obtained Thereby

An embodied visualization and tracking system was prepared and evaluated in a field setting.

Toward this end, the following components were purchased and assembled within a barrel used for encasing construction materials.

The Raspberry Pi 4 microprocessor was purchased for use as the microprocessor component of the local data collection unit in the embodied visualization and tracking system. A memory storage card was also operationally connected to the microprocessor. Multiple miniaturized HD wireless camera SQ11 containing motion detectors for activation of the HD cameras and built-in microphones for recording sound were operationally connected to the microprocessor, via the aid of an analog multiplexer (Usb Mux 4:1 Module MAX4899AE) and adapters as needed (Chip Quik Inc. PA0061-ND QFN-16 TO DIP-16 SMT ADAPTER). A gyroscope/accelerometer (the SEN0142 Sensor position accelerometer gyroscope from DFROBOT) and pedometer (Digital 3D Pedometer Module DSPX01 from Dorji Applied Technologies) were also operationally connected to the microprocessor. The communication transmission elements further constituting the local data collection unit of this embodied system included the RASPBERRYPI 3G-4G/LTE Base Shield V2 interface bridge as the interface between the SIM (Quectel EC25-E Mini PCIE 4G/LTE Module) and Raspberry Pi microprocessor and the system further incorporated an antenna (LTE Main & Diversity & GNSS Triple Port u.FL Antenna). Lithium batteries powered the local data collection unit, which were commercially available. The layout of the components of the local data collection unit was similar to that depicted in FIG. 3.

Following assembly and verification of connectivity/function of the local data collection unit, which was then deployed in a field setting. Specifically, a large barrel purchased from a cement supplier was retrofitted to carry the local data collection units in the barrel framework. The barrel was then carried into an underground testing bunker and data was recorded in terms of camera images, and location information compiled via the gyroscope/accelerometer and correlated with data obtained via the pedometer.

The data receiving unit employed was a standard cell phone and laptop computer whereby the cell phone was utilized to transmit the data to the laptop computer for further data processing.

FIGS. 4A-4I depict a putative scenario of deployment of an embodied local data collection unit, in a field setting. A similar test setting was used to deploy the embodied local data collection unit as described herein.

FIG. 5 depicts a plot of spatial data obtained following deployment of the described visualization and tracking system hereinabove, deployed in a subterranean setting.

FIG. 6 plots the spatial data as described in FIG. 5 over a satellite map at a defined geographic locale.

FIGS. 7A-7E schematically depict the interface of the activation of transmission of data from the embodied local data collection unit and FIG. 8 depicts the compressed encrypted data files transmitted from the local data collection unit to the data receiving unit.

FIG. 9A provides a sample image collected by the local data collection unit, and transmitted as a compressed encrypted image file to the embodied data receiving unit. FIG. 9B provides plotted spatial data obtained following deployment of the described visualization and tracking system hereinabove, deployed in a second subterranean setting.

1.-19. (canceled)

20. A visualization and tracking system comprising:
a local data collection unit, comprising:
a microprocessor;
one or more sensor activated cameras;
a gyroscope and accelerometer assembly and optionally a pedometer;
communication transmission elements;
a power supply/batteries, and
a remote data receiver unit comprising secure communication receiver elements, a processor and a server.

21. The visualization and tracking system of claim 20, further comprising a memory storage module.

22. The visualization and tracking system of claim 21, wherein said memory storage module comprises an SD card.

23. The visualization and tracking system of claim 20, further comprising a voice-activated audio recording device.

24. The visualization and tracking system of claim 20, wherein communication between said local data collection unit and the remote data receiver unit is with the aid of a subscriber identification module (SIM).

25. The visualization and tracking system of claim 24, wherein said SIM securely stores a key for identification and unique authentication for access by said remote data receiver unit.

26. The visualization and tracking system of claim 20, wherein data collected and stored on said microprocessor is encrypted, compacted or a combination thereof.

27. The visualization and tracking system of claim 20, wherein data collection by said local data collection occurs based on motion.

28. The visualization and tracking system of claim 20, wherein data collection by said local data collection unit is programmed to occur based on a predetermined time schedule.

29. The visualization and tracking system of claim 20, wherein data collection by said local data collection unit is programmed to occur based on proximity of said local data collection unit to a predetermined geographic location.

30. The visualization and tracking system of claim 20, wherein data transmission is pre-programmed to occur based on receipt of a signal by said local data collection unit from said remote data receiver unit.

31. The visualization and tracking system of claim 20, wherein data received by said remote data receiver unit is encrypted, compacted or a combination thereof.

32. The visualization and tracking system of claim 20, wherein data transmission from said local data collection unit to said remote data receiver unit may occur repeatedly over time.

33. The visualization and tracking system of claim 20, wherein data transmission from said local data collection unit to said remote data receiver unit, results in deleting of previously stored transmitted data.

34. The visualization and tracking system of claim 20, further comprising a digital compass.

35. A method for visualization and tracking of a target, said method comprising:
providing a local data collection unit to or at a target whose visualization and tracking is desired;
wherein said local data collection unit comprises:
a microprocessor;
one or more sensor activated cameras;
a gyroscope;
a power source; and
communication transmission elements; and optionally
a pedometer;
providing a remote data receiver unit comprising secure communication receiver elements,
promoting secure communication between said local data collection unit and said remote data receiver unit;
whereby data collected and stored on the local data collection unit is securely transmitted to said remote data receiver unit;
processing data received by said data receiver unit in terms of visualization and tracking of said target.

36. The method of claim 35, further comprising detection and tracking of multiple targets simultaneously.

37. The method of claim 35, wherein said target is a location.

38. The method of claim 35, wherein said target is an individual.

39. The visualization and tracking system of claim 33, wherein data transmission from said local data collection unit to said remote data receiver unit, results in deleting of previously stored transmitted data.
